(19) United States
(12) Patent Application Publication
(10) Pub. No.: US 2003/0165242 A1
(43) Pub. Date: Sep. 4, 2003

(54) Confusion encryption

(76) Inventor: Adrian Walker, Bristol, CT (US)

Correspondence Address: ADRIAN WALKER, REENGINEERING LLC, PO Box 1412, BRISTOL, CT, 06011, US

(21) Appl. No.: 09/988,300

(22) Filed: Nov. 19, 2001

(51) Int. Cl. H04K 1/00

(52) U.S. Cl. 380/277

(57) ABSTRACT

A method and system are described to allow the encryption and decryption of a plaintext string of symbols, e.g. a paragraph of English text, using a key consisting in part of an executable computer program. The method and system is such that an attacker who seeks to recover the plaintext from the ciphertext, without knowing the key, can produce a very large number of decrypt attempts that are plausible, but unrelated in meaning to the original plaintext. However the attacker cannot know whether any one of the attempted decrypts is the correct original plaintext. A property of the method and system is that, if the same plaintext is encrypted twice using the same key, the respective ciphertexts are normally different, and normally have different lengths.

### CROSS-REFERENCE TO RELATED APPLICATIONS

I sent a provisional patent application with the above title and same inventor name, by US Mail to the USPTO, on Nov. 5, 2001.

### STATEMENT REGARDING FEDERALLY SPONSORED RESEARCH OR DEVELOPMENT

The work described herein was not sponsored by any government.

### BACKGROUND OF THE INVENTION

This invention relates to a method and apparatus for cryptographically transforming a sequence of symbols particularly, to a method and apparatus for encrypting or decrypting a sequence that may represent text, audio, graphic, video or other data.

Cryptographic systems are well known in the computation art. In general, such systems divide a plaintext to be encrypted into a sequence of fixed length blocks (the last block being padded to the fixed length if necessary). The systems then operate by performing an encryption operation on a plaintext input block, using an encryption key, to produce a ciphertext output block. The receiver of an encrypted message performs a corresponding decryption operation, using a decryption key, to recover the plaintext block.

Encryption systems fall into two general categories: asymmetric encryption systems and symmetric encryption systems. Asymmetric (or public key) encryption systems use different keys that are not easily derivable from one another for encryption and decryption. A person wishing to receive messages generates a pair of corresponding encryption and decryption keys. The encryption key is made public, while the corresponding decryption key is kept secret. Anyone wishing to communicate privately with the receiver may encrypt a message using the receiver's public key. Only the receiver may decrypt the message, however, since only he has the private key. Perhaps the best-known asymmetric encryption system is the RSA encryption system, named after its originators Rivest, Shamir and Adleman and described in B. Schneier, Applied Cryptography (1996), pages 466-474.

Symmetric (or private key) encryption systems, on the other hand, use the same secret key for both encrypting and decrypting messages. Although symmetric encryption systems require some secure means for distributing or agreeing upon secret encryption keys, they continue to be preferred for many applications because of their relative computational efficiency.

Perhaps the best-known symmetric encryption system is the Data Encryption Algorithm (DEA), implementing the Data Encryption Standard (DES) as described in the National Institute of Standards and Technology (NIST) publications “Data Encryption Standard (DES)”, FIPS PUB 46-2 (1980), and “DES Modes of Operation”, FIPS PUB 81 (1988). In the DES system, a 64-bit key is used to transform a plaintext message comprising one or more 64-bit plaintext blocks into a ciphertext message comprising a like number of 64-bit ciphertext blocks, or vice versa. (56 bits of the key are independently specifiable, while the remaining 8 bits provide a parity check.)

At the time of its initial promulgation, the 56-bit key length and 64-bit block length of DES were thought to provide adequate protection against cryptographic attacks, including key exhaustion attacks based upon systematically testing all possible keys and dictionary attacks based upon building a “dictionary” of corresponding plaintext and ciphertext blocks. However, continued advances in computing speed have made such brute-force attacks feasible.

The National Institute of Standards and Testing (NIST) has called for a complete replacement of DES, called the Advanced Encryption Standard (AES), to be deployed sometime in the future, see http://csrc.nist.gov/encryption/aes.

Each of the systems in the prior art described so far, including the Advanced Encryption Standard finalist candidate algorithms MARS, RC6, Rinjdael, Serpent and Twofish, (http://csrc.nist.gov/encryption/aes/round2/round2.htm#algorithms) has a particular weakness with respect to an exhaustive key search attack. Suppose that the plaintext is a meaningful collection of English sentences. Then, in the prior art, almost all attacks, in which a trial key is used to decode a ciphertext, will result in meaningless strings of symbols. If some meaningful English emerges, the attacker can be fairly sure that the right key has been found.

In U.S. Provisional Patent Application Serial No. 60/291,482, filed May 16, 2001, Benjamin and Walker describe a method of Semantic Encoding of relational databases. Semantic Encoding has the property that an attacker who does not know a key can reasonably produce many plausible but misleading database tables as attempted decodes, but cannot know which of those, if any, is correct. Semantic Encoding hides the relationship between items in a database table, but it does not address the core matters, such as encryption of English text, that are handled by DES, RSA, AES, and the present invention.

Each of the systems in the prior art, except for Semantic Encoding of databases, relies for its security on the difficulty of mathematical and computational problems that are in principle solvable. Advances in mathematics and computation, such as massively parallel biocomputation, can at any time render the systems in the prior art completely insecure.

### SUMMARY OF THE INVENTION

To overcome the limitations in the prior art described above, and to overcome other limitations that will become apparent upon reading and understanding the present specification, the present invention discloses a method, system, apparatus, and article of manufacture for a computer implemented Encrypter and Decrypter. According to the present invention, encryption and decryption of a plaintext string of symbols, e.g. a paragraph of English text, uses a key consisting in part of an executable computer program. The method and system is such that an attacker who seeks to recover the plaintext from the ciphertext, without knowing the key, can produce a very large number of decrypt attempts that are plausible, but unrelated in meaning to the original plaintext. However the attacker cannot know whether any one of the attempted decrypts is the correct original plaintext. A property of the method and system is that, if the same plaintext is encrypted twice using the same key, the respective ciphertexts are different, and have different lengths.

For example, suppose that in the present method system, the plaintext to be encrypted is:

Confusion encryption does not rely for its security on the difficulty of hard but solvable mathematical problems

Using a particular key, of the form described hereinafter, a corresponding ciphertext in the present method and system is:

RKb4lLnl8cU2hYbH7hKaQA7eZr57sg9bnks5eMcbLfnbMZtaQ7o3NXwrY3 vNrxLTeQbkKotnxMOddISXMefq7ro8Mg1qjipKVMqssWbgomhcS6oi7sAt 6m03 wfft91WDeHxFAyaL5 LmP7c8UO7XyaioVjo9 ZhvGYoXkdeLDNump xZOSKucHkpsMjAO ulmIlvrQrVeOli8Mbcr Mrt87tCnNcKdJ8s1bv6QfH znKi7csjuGynMiolm0I5lbN7Pwbfzgx5mzXci nqtys9TGeuA2MhdrSJn3 L7slA0JtQ9hZX6dVcmZ yFW1t8xcVDysZf1HGdsbovoqt6Gc So0X18ytO lVeJQ cbSfjNfFoRMOVeAVDcvGJACvoWXCPmYzR1yxqYn 397heRceGxCT hY1ilta4P9Kta3Z5fhCmD o0ut9majekH3Fp3Nr jzdoctcgHPluD1axis WU3 k5HSmgnhc8k8 TXzuNoINVvoWQNLoSl6Kt07iYKCRetG47v5jkjwnv COacaHd dN3gaWCGyaUeKnkweVNFt7Lxcitv3c DjWP58d5w 7i 5M7OCr puyvsjqcfyvlO3ikQPlQcMe MHP3uctYiFjaxnm2dc

The above ciphertext actually contains the symbols of the plaintext, but their positions are permuted and they are surrounded by padding symbols. An object of the method and system is that the permutation can be made over the complete length of the plaintext, so that it is not limited to a block length in the manner of the prior art. Another object of the method and system is that, if so desired, it can be used to encrypt plaintext block-by-block; however, the blocks need not be of equal length in the manner of the prior art. Another object of the method and system is that, if the same plaintext is encrypted twice using the same key, the respective ciphertexts are normally different, and normally have different lengths. This is possible because the key contains random computations, whose results are encoded into the padding symbols, in the manner described hereinafter.

Thus an attacker may only know that the plaintext contains a permutation of some of the symbols of the ciphertext. In this situation, an attacker who seeks to recover the plaintext from the ciphertext, without knowing the key, can produce a very large number of decrypt attempts that are plausible, but unrelated in meaning to the original plaintext. However, the attacker cannot know whether any one of the attempted decrypts is the correct original plaintext. For example, the attacker can produce the following attempted decrypt using the symbols from the above ciphertext:

The committee meets next at 9am on August 11th in room 12 of the research center

The attempted decrypt is plausible, but it is unrelated to the original plaintext above. There are many other such plausible but misleading attempted decrypts.

As another example, suppose that the plaintext consists of the following 10-digit pin number for an automated teller machine account:

1236547890

Using a particular key, of the form described hereinafter, a corresponding ciphertext in the present method and system is:

Ot78V389307p5n591v503Q2342s37Cyo9184366417nE9251z73n682006tr0807S242

The ciphertext contains more digits than the plaintext pin number, and an attacker can choose any 10 of those digits, in any order, to form an attempted decrypt. However, the attacker cannot know whether any result from such attempts is the original plaintext pin number.

### BRIEF DESCRIPTION OF THE SEVERAL VIEWS OF THE DRAWING

FIG. 1 is a block diagram of the hardware and software environment of a system according to the present invention.

FIG. 2 is a flow diagram of the encrypter according to the present invention.

FIG. 3 is a continued flow diagram of the encrypter according to the present invention.

FIG. 4 is a flow diagram of the decrypter according to the present invention.

FIG. 5 is a continued flow diagram of the decrypter according to the present invention.

FIG. 6 is a continued flow diagram of the decrypter according to the present invention.

### DETAILED DESCRIPTION OF THE INVENTION

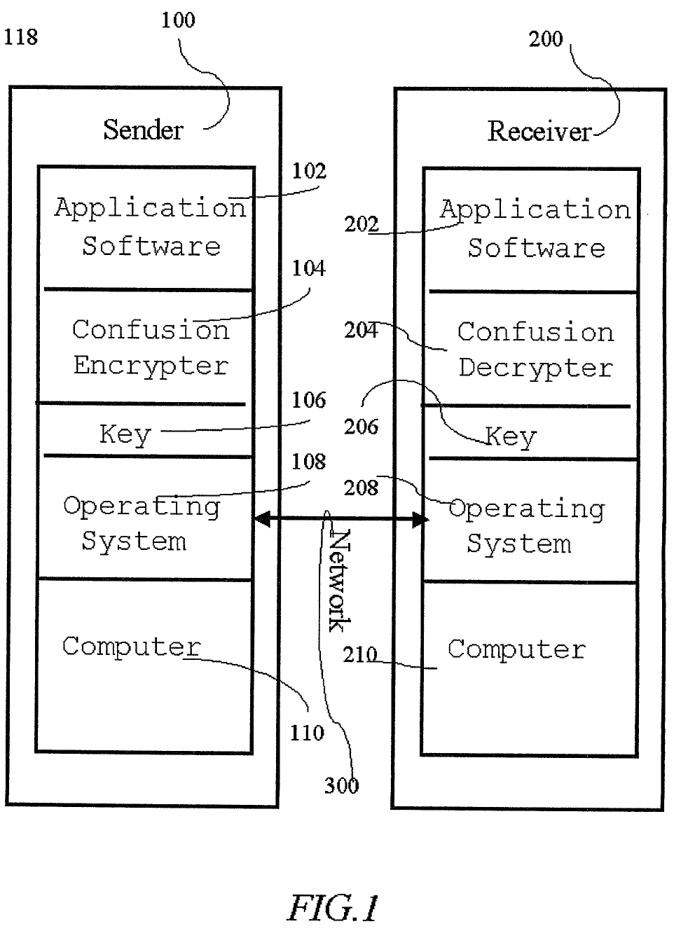

FIG. 1 is an exemplary hardware and software environment used to implement the preferred embodiment of the invention. The present invention is typically implemented using one or more computers 110, 210, which are connected by a network 300. Each computer or will normally have an operating system 108, 208 (e.g., Unix), and various items of application software 102, 202. If Confusion Encryption is to be used to send files of text, or other data, securely from one computer to another, then one computer system will be a Sender, 100, and the other computer system will be a Receiver, 200. The Sender, 100, will have Confusion Encrypter hardware and/or software installed, 104. The Receiver, 200, will have Confusion Decrypter hardware and/or software installed, 204 . The Sender, 100 and the Receiver, 200, will have copies of a Key 106, respectively 206. If it is desired to send files securely in both directions, then each of the computers 110, 210 will have both an Encrypter 104 and a Decrypter 204 installed.

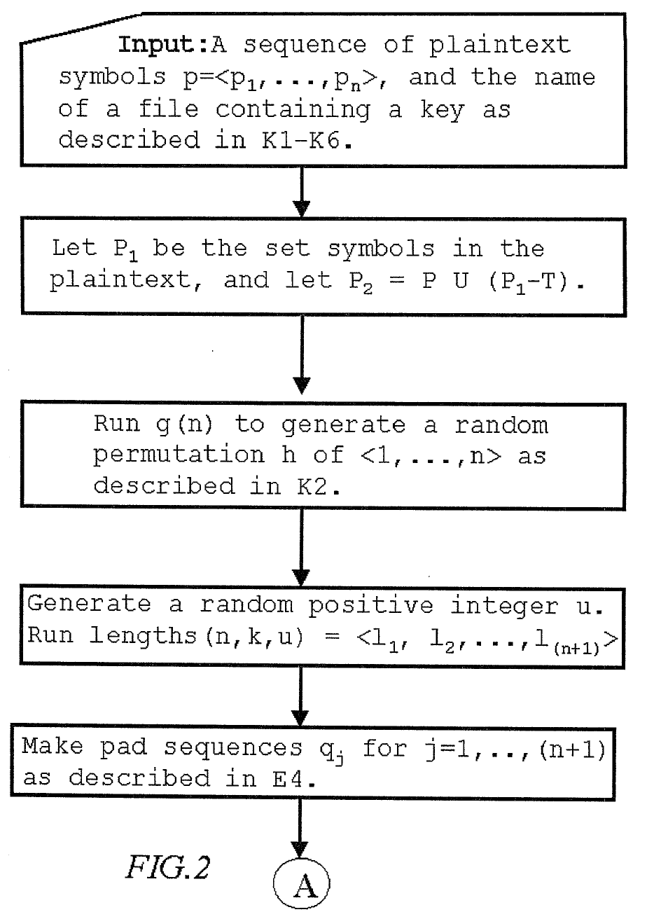

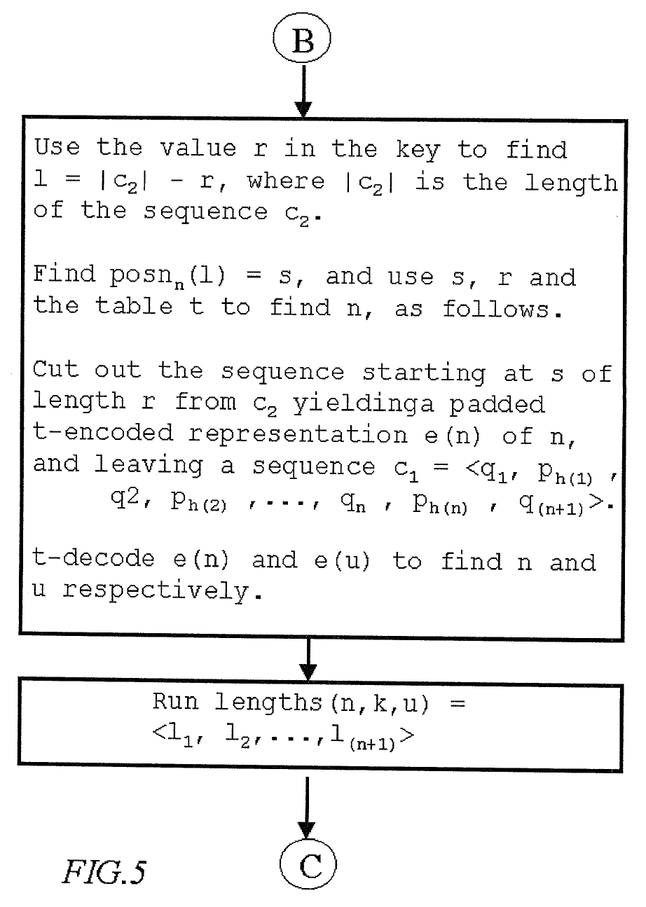

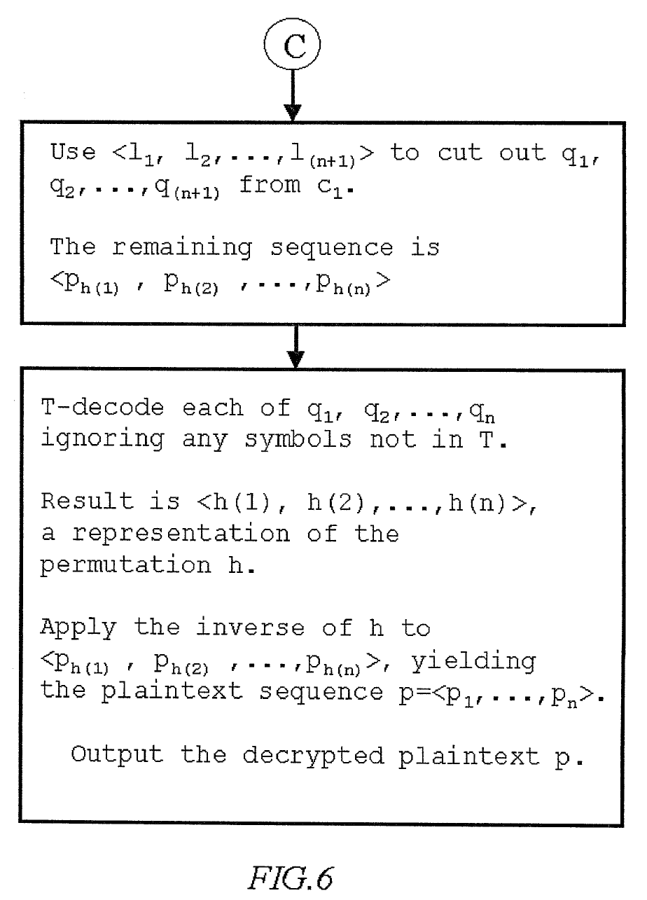

One skilled in the art will readily see how the components in FIG. 1 are used to realize various embodiments of the present invention as described in FIGS. 2-6. The present invention may be implemented as a method, apparatus, or article of manufacture using standard programming and/or engineering techniques to produce software, firmware, hardware, or any combination thereof. The term “article of manufacture” (or alternatively, “computer program”) as used herein is intended to encompass a computer program accessible from any computer-readable device, carrier, or media. Of course, those skilled in the art will recognize that many modifications may be made to this configuration without departing from the scope of the present invention.

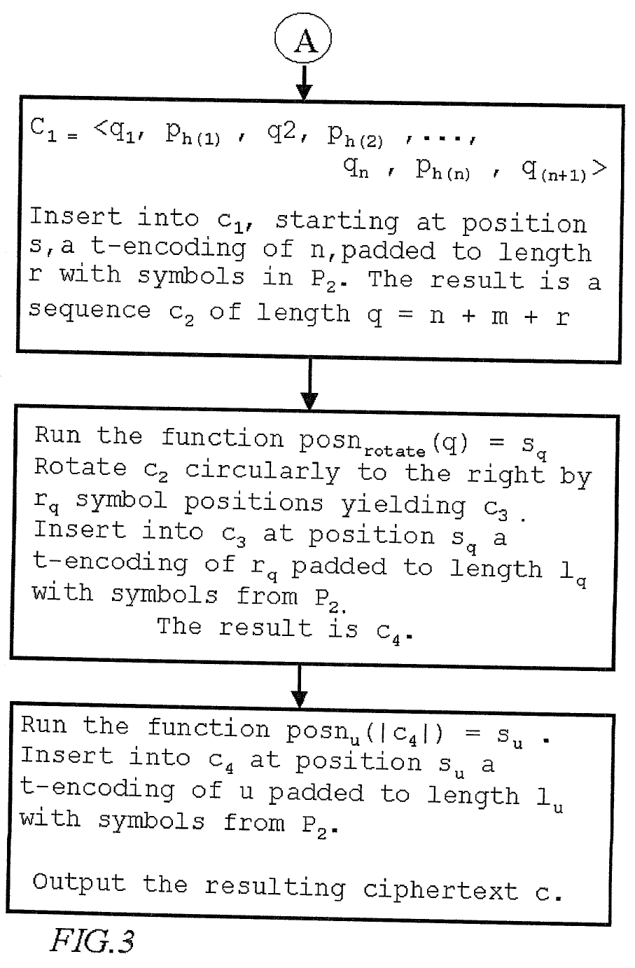

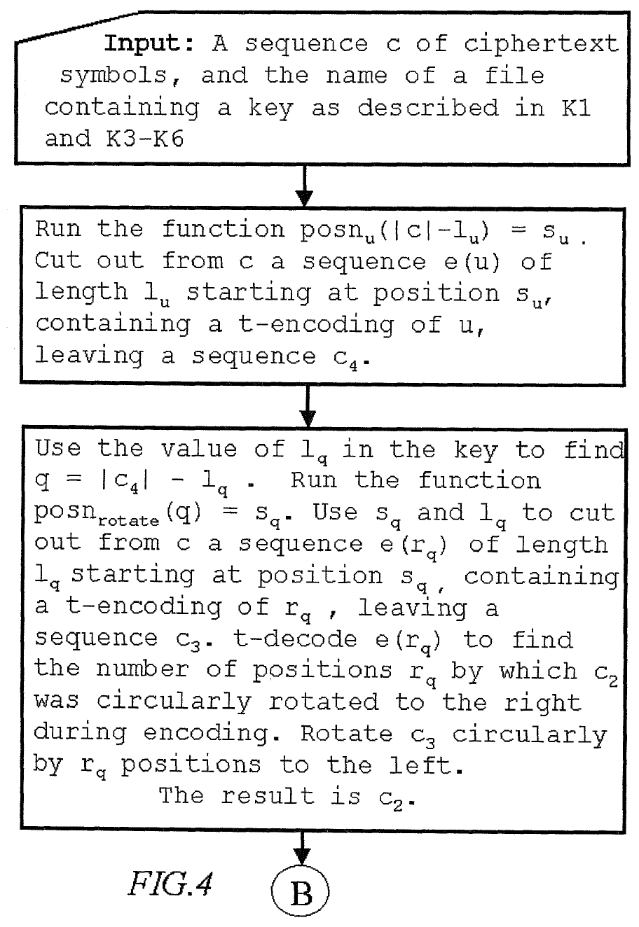

The preferred embodiment, described hereinafter and illustrated in FIGS. 2-6, represents the various subparts to the system of the present invention: Encrypter (FIGS. 2-3); Decrypter (FIGS. 4-6); each subpart will be discussed in detail hereinafter.

The preferred embodiment consists of a key, an Encrypter, and a Decrypter, as follows.

Key

Unlike the keys used in the prior art, a key for the present method and system, confusion encryption and decryption, consists in part of mathematical functions that can be implemented as computer programs. In the preferred embodiment, the following components of a key are specified, in a file that is made known at run time to the Encrypter program or to the Decrypter program as needed. Thus, a different key can be used by making a different key file known to the Encrypter or Decrypter. The components of a key are described in K1-K6 below. K1-K6 also serve to introduce some notation that will be used to describe the Encrypter and Decrypter.

K1. A set of symbols P to be used for padding, and a set of symbols T, disjoint from P, to be used for t-encoding. (t-encoding is defined below.) T shall contain some, but not all, of the symbols expected in the plaintext that is to be encoded.

K2. A random permutation generator g(n), where n is the length of the plaintext.

g(n) produces a permutation h, such as <5,1,3,2,4, . . . >, that will be used to permute the plaintext. In this example, the 5th symbol of the plaintext will be moved to the first position, the first symbol will moved to the second position, and so on.

g(n), for a given n, shall produce a different permutation h from successive computations. For example, g(n) may contain a pseudo-random number generator, or a genuine source of random numbers, of the kinds familiar to one skilled in the art.

g(n) shall have the property that h does not have any sequential subseqence of length 3. For example, the permutation h=<5,2,3,4,1, . . . > shall not be generated, because it contains the subseqence <2,3,4>.

K3. An integer k>1 and a function lengths (n,k,u)=<l₁, l₂, . . . , l₍ₙ₊₁₎>, the lengths of some padding regions to be included in the ciphertext.

u is an integer chosen at random during encryption. During decryption, a t-encoded form of u will be retrieved from the ciphertext. (t-encoding is described in K5 below.)

The lengths lⱼ produced by lengths(n,k,u) shall each lie in the region

[log n]=<lⱼ=<k*[log n]

where [log n] denotes the smallest integer greater than log n, and log n denotes a logarithm to base 10 of n. The lengths shall appear to be randomly chosen within the range, but each computation of lengths (n,k,u) for a given n, k, and u, shall produce the same output.

K4. Let l₁+ . . . +l₍ₙ₊₁₎=m, and let l=n+m

A function posnₙ(l)=s, 1<s<l,

This function produces a number s that shall be the start position at which a padded t-encoding of the number n will be inserted into a first version of the ciphertext. The padded t-encoding of n, as defined below, shall be of length r, where r is a fixed number that is part of the key.

K5. t-encoding

A table t, having two columns, for example

0 a,g,w,9,2

1 D,u,q,7

.. . . .

9 p,Z,c,3

The table t indicates a way of encoding each of the digits 0-9 in more than one way. In this example, the sequence <p,u,2> is a t-encoding of the number 910, and so is the sequence <3,D,g>.

The right hand column of the table t only contains symbols from T, as Defined in K1 of the key. No symbol shall appear more than once in the right hand column of t.

A t-encoding of a number is made by choosing a translation of each digit j of the number using the entries on line j in the right column of the table t at random, e.g. using a pseudo-random number generator of the kind familiar to one skilled in the art. The reverse translation is deterministic, and we call it a t-decoding. If a t-encoded sequence is padded with extra symbols not in T, it can be t-decoded by simply ignoring those extra symbols. For example, if the symbols ‘b’ and ‘h’ are not in the set T, the sequence <b,3,h,D,g,h> t-decodes to the number 910 using the above table t.

K6. Let q=n+m+r

Let l_{q} be a fixed length large enough to contain a t-encoding of q

Let r_{q} be a random number in the range 1<r_{q}<q, indicating a number of to circularly rotate a string of length q.

A function posnᵣₒₜₐₜₑ(q)=s_{q}, 1<s_{q}<q, where s_{q} is the start position of a region of length l_{q} that is to contain a padded t-encoding of r_{q}

Let lᵤ be a fixed length large enough to contain a t-encoding of u. lᵤ is a part of the key.

A function posnᵤ(v)=sᵤ, 1<sᵤ<v, where sᵤ is the start position of a region of length lᵤ that is to contain a padded t-encoding of u.

Encrypter

Input: A sequence of plaintext symbols p=<p₁, . . . ,pₙ>, and the name of a file containing a key as described in K1-K6.

Output: Ciphertext c

E1. Let P₁ be the set symbols in the plaintext, and let P₂=P U (P₁-T).

E2. Run g(n) to generate a random permutation h of <1, . . . ,n> as described in K2.

E3. Generate a random integer u.

Run lengths (n, k, u)=<l₁, l₂, . . . ,l₍ₙ₊₁₎>

E4. Make pad sequences qⱼ for j=1, . . . , (n+1) as follows:

qⱼ for j=1, . . . ,n is of length lⱼ, and consists of h(j) t-encoded as described in K5, interleaved in random positions with symbols chosen at random from P₂.

q(n+1) is randomly chosen padding, of length l₍ₙ₊₁₎, using the symbols of P₂ U T.

E5. Let c₁ be the sequence of symbols

<q₁, pₕ₍₁₎, q2, pₕ₍₂₎, . . . , qₙ, pₕ₍ₙ₎, q₍ₙ₊₁₎>

Insert into c₁, starting at position s, a t-encoding of n, padded to length r with symbols in P₂.

The result is a sequence c₂ of length q=n+m+r

E6. Run the function posnᵣₒₜₐₜₑ(q)=s_{q}

Rotate c₂ circularly to the right by r_{q} symbol positions yielding c₃.

Insert into c₃ at position s_{q} a t-encoding of r_{q} padded to length l_{q} with symbols from P₂.

The result is a sequence c₄.

E7. Run the function posnᵤ(|c₄|)=sᵤ, where |c₄| is the length of c₄.

Insert into c₄ at position sᵤ a t-encoding of u padded to length lᵤ with symbols from P₂.

The result is the ciphertext c.

Decrypter

Input: A sequence c of ciphertext symbols, and the name of a file containing a key as described in K1 and K3-K6.

Output: A sequence p of plaintext symbols.

D1. Use the value of lᵤ in the key to run the function posnᵤ (|c|−lᵤ)=sᵤ, where |c| is the length of the sequence c.

Use sᵤ and lᵤ to cut out from c a sequence e(u) of length lᵤ starting at position sᵤ, containing a t-encoding of u, leaving a sequence c₄.

D2. Use the value of l_{q} in the key to find q=|c₄|−l_{q}.

Run the function posnᵣₒₜₐₜₑ(q)=s_{q}.

Use s_{q} and l_{q} to cut out from c₄ a sequence e(r_{q}) of length l_{q} starting at position s_{q}, containing a t-encoding of r_{q}, leaving a sequence c₃.

t-decode e(r_{q}) to find the number of positions r_{q} by which c₂ was circularly rotated to the right during encoding.

Rotate c₃ circularly by r_{q} positions to the left. The result is c₂.

D3. Use the value r in the key to find l=|c₂|−r.

Find posnₙ(l)=s, and use s, r and the table t to find n, as follows.

Cut out the sequence starting at s of length r from c₂ yielding a padded t-encoded representation e(n) of n, and leaving a sequence c₁=<q₁, pₕ₍₁₎, q2, pₕ₍₂₎, . . . qₙ, pₕ₍ₙ₎, q₍ₙ₊₁₎>. t-decode e(n) to find n. t-decode e(u) to find u.

D4. Run the function lengths(n,k,u) to produce <l₁, l₂, . . . ,l₍ₙ₊₁₎>

D5. Use <l₁, l₂, . . . ,l₍ₙ₊₁₎> to cut out q₁, q₂, . . . ,q₍ₙ₊₁₎ from c₁.

The remaining sequence is <pₕ₍₁₎, pₕ₍₂₎, . . . ,pₕ₍ₙ₎>

D6. t-decode each of q₁, q₂, . . . ,qₙ.

The result of the t-decode is <h(1), h(2), . . . ,h(n)>, a representation of the permutation h.

Apply the inverse of h to <pₕ₍₁₎, pₕ₍₂₎, . . . ,pₕ₍ₙ₎>, yielding the plaintext sequence p=<p₁, . . . ,pₙ>.

This concludes the detailed description of the invention. The following describes some alternative embodiments for accomplishing the present invention. For example, any type of computer, such as a mainframe, minicomputer, or personal computer, or computer configuration, such as a timesharing mainframe, local area network, virtual private network, peer-to-peer network, or standalone personal computer, could be used with the present invention. The permutations used in the invention can be generated by many different methods, including software and/or hardware based pseudo-random number generators, software and/or hardware based encryption methods, or natural sources of truly random numbers.

In summary, the present invention discloses a method, system, apparatus, and article of manufacture to support the encryption and decryption of a plaintext string of symbols, e.g. a paragraph of English text, using a key consisting in part of an executable computer program. The method and system is such that an attacker who seeks to recover the plaintext from the ciphertext, without knowing the key, can produce a very large number of decrypt attempts that are plausible, but unrelated in meaning to the original plaintext. However the attacker cannot know whether any one of the attempted decrypts is the correct original plaintext.

The foregoing description of the preferred embodiment of the invention has been presented for the purposes of illustration and description. It is not intended to be exhaustive or to limit the invention to the precise form disclosed. Many modifications and variations are possible in light of the above teaching. For example, the symbols of the plaintext can be shifted alphabetically before confusion encryption is applied. As another example, one skilled in the art will easily see how the invention can be applied such that the confusion encrypter, rather than permuting the plaintext over its entire length, permutes the plaintext block-by-block, where the blocks need not all be of the same length. As another example, confusion encryption can be applied to the plaintext to produce ciphertext, then applied to the ciphertext, using a different key, to produce further ciphertext; such a process can be repeated several times. It is intended that the scope of the invention be limited not by this detailed description, but rather by the claims appended hereto.

What I claim as my invention is:

1. A computer-implemented method and system for encryption and decryption of text audio, graphic, video or other data, comprising steps such that:
an attacker who seeks to recover a plaintext from a ciphertext, who may or may not know the general encryption method, but who does not know the specific key used for encryption, can reasonably select and arrange some of the symbols of the ciphertext to produce a very large number of decrypt attempts that are plausible, but that are unrelated in meaning to the original plaintext; and
an attacker who seeks to recover a plaintext from a ciphertext, who may or may not know the general encryption method, but who does not know the specific key used for encryption, cannot know whether any one of a number of attempted decrypts he produces, by means of a reasonable selection and arrangement of some of the symbols of the ciphertext, is a correct original plaintext.

2. The method of claim 1, further comprising steps such that, if the same plaintext is encrypted twice using the same key, the respective ciphertexts may be different.

3. The method of claim 1, further comprising steps such that, if the same plaintext is encrypted twice using the same key, the respective ciphertexts may have different lengths.

4. The method of claim 1, further comprising steps in which a key for encryption and decryption contains a named integer.

5. The method of claim 1, further comprising steps in which a key for encryption and decryption contains a named set of symbols.

6. The method of claim 1, further comprising steps in which a key for encryption and decryption contains an executable computer program.

7. The method of claim 6, further comprising steps in which a key for encryption and decryption contains an executable computer program, in object code form, that is made known to an encryption program at run time, and that is made known to a decryption program at run time.

8. The method of claim 6, further comprising steps in which a key for encryption and decryption contains an executable computer program that generates and uses pseudo random numbers.

9. The method of claim 6, further comprising steps in which key for encryption and decryption contains an executable computer program that makes use of a source of genuinely random numbers.

10. The method of claim 1, further comprising steps in which a key contains a table describing an encoding of a digit in the range 0-9 into two or more choices of symbols, such that a symbol amongst the choices for a given digit does not occur amongst the choices for any other digit.

11. The method of claim 1, further comprising steps in which a key contains a pseudo random number generator, or makes use of a generator of genuinely random numbers, the generator generating a permutation of the numbers 1, . . . ,n, where n is given as input to the generator.

12. The method of claim 11, further comprising steps in which the generator generates only a permutation that does not contain any sequential subseqence of a specified length.

13. The method of claim 1, further comprising steps in which a key contains a function depending on the length of a plaintext to be encrypted or decrypted, depending also on a named integer that is part of the key, and depending also on a pseudo random or genuinely random integer, the function producing a sequence of apparently random integers in a prescribed range.

14. The method of claim 1, further comprising steps in which in which a key contains a program capable of encoding a number, digit-by-digit, into a sequence of symbols, using a pseudo random number generator, or using a source of genuinely random numbers, the pseudo random or genuinely random numbers being used to choose amongst the choices in a table for the encoding of each digit.

15. The method of claim 14, further comprising steps in which in which a sequence encoding a positive number, is padded, digit-by-digit, with additional symbols not among the choices in a table, but including symbols from an input plaintext, using a pseudo random number generator, or using a source of genuinely random numbers, to choose the padding symbols.

16. The method of claim 15, further comprising steps in which in which a padded sequence that encodes a positive number, is decoded digit-by-digit, using a table, ignoring padding symbols not among the choices in the table, to obtain the unencoded number.

17. The method of claim 1, further comprising steps in which a key contains a function with one input integer, that produces as output an integer in the range between 0 and the input, that output being used as the start position in which a sequence of padded encoded information is inserted into a ciphertext.

18. The method of claim 1, further comprising steps in which an encrypter permutes the positions of all of the symbols in an input plaintext sequence, according to a given permutation, the permutation being performed over the entire length of the plaintext sequence.

19. The method of claim 1, further comprising steps in which an encrypter permutes the positions of the symbols in subsequence blocks of an input plaintext sequence, according to a given permutation, the subsequence blocks not necessarily all being of the same length.

20. The method of claim 1, further comprising steps in which an encrypter places padding of different lengths, between those symbols in a ciphertext that originate from a plaintext.

21. The method of claim 1, further comprising steps in which an encrypter places padding of different lengths, containing encoded information about the encryption process, between those symbols in a cyphertext that originate from a plaintext.

22. The method of claim 1, further comprising steps in which an encrypter places padding, containing copies of symbols in the that occur in plaintext, between those symbols in a cyphertext that originate from a plaintext.

23. The method of claim 1, further comprising steps in which an encrypter places padding of different lengths, at the start and/or end of a ciphertext.

24. The method of claim 1, further comprising steps in which an encrypter places padding of different lengths, containing encoded information about the encryption process, at the start and/or end of a ciphertext.

25. The method of claim 1, further comprising steps in which an encrypter places padding, containing copies of symbols in the that occur in plaintext, at the start and/or end of a ciphertext.

26. The method of claim 1, in which a ciphertext is circularly rotated during encryption, by a number of positions that is placed as padded encoded information in the ciphertext.

27. The method of claim 1, in which a ciphertext is circularly rotated during decryption, by a number of positions that is placed as padded encoded information in the ciphertext during encryption.

28. The method of claim 1, in which a key contains a function that a decrypter may use to find, from a length of a given ciphertext, a start position of a region of padded encoded information in the ciphertext, the information being about how the ciphertext was created from the plaintext during encryption.

29. The method of claim 1, in which a key contains a function that a decrypter may use to separate plaintext symbols from padding.

30. The method of claim 1, in which a key contains a function that a decrypter may use to separate plaintext symbols from padding, the padding containing encoded information about a permutation used to permute the positions plaintext symbols during encryption.

31. The method of claim 1, in which a key contains a function that a decrypter may use to apply an inverse permutation to a permuted sequence of plaintext symbols in order to recover an original sequence of plaintext symbols.

32. The method of claim 1, in which the plaintext symbols are sytematically translated into other plaintext symbols.

33. An apparatus for for encryption and decryption of text audio, graphic, video or other data, comprising at least one computer.

34. An apparatus for for encryption and decryption of text audio, graphic, video or other data, comprising two or more computers connected over at least one network.
